(19) United States
(12) Patent Application Publication
(10) Pub. No.: US 2011/0057487 A1
(43) Pub. Date: Mar. 10, 2011

(54) SEAT STRUCTURE OF VEHICLE

(75) Inventor: Takashi SUZUKI, Hiroshima (JP)

(73) Assignee: MAZDA MOTOR CORPORATION, Hiroshima (JP)

(21) Appl. No.: 12/839,064

(22) Filed: Jul. 19, 2010

(30) Foreign Application Priority Data
Sep. 7, 2009 (JP) 2009-205749

(51) Int. Cl. B60N 2/427; B60N 2/42; B60R 21/16

(52) U.S. Cl. 297/216.13; 280/730.2

(57) ABSTRACT

A seat structure of a vehicle, comprising a seatback frame which is provided on a vehicle-inside of a seatback which is provided at a rear portion of a seat cushion and supports a back of a passenger, a side frame which extends vertically beside the seatback frame, and a pad member which covers the side frame, the pad member forming a shape of the seatback, wherein an impact reduction portion to reduce an impact from a vehicle side is provided at the side frame. Accordingly, the seat structure of a vehicle which can reduce the impact load from the vehicle side portion at the vehicle side collision and thereby properly decrease the load inputting to the passenger's chest portion can be provided.

### BACKGROUND OF THE INVENTION

The present invention relates to a seat structure of a vehicle comprising a seatback frame provided on a vehicle-inside of a seatback, a side frame extending vertically beside the seatback frame, and a pad member covering the side frame, the pad member forming a shape of the seatback.

In general, the seat structure of a vehicle comprises the seatback frame provided on the vehicle-inside of the seatback which is provided at a rear portion of the seat cushion of the seat and supports the back of a passenger seated in the seat, the side frame extending vertically beside the seatback frame, and the pad member covering the side frame, the pad member forming the shape of the seatback. Herein, this seat structure of a vehicle equipped with the side frame has a problem in that when a load (impact load) is inputted to the passenger seated in the seat from the vehicle side at a vehicle side collision, the side frame may hit against a chest portion of the passenger, so that the impact acting on the passenger may become improperly large.

Japanese Patent Laid-Open Publication No. 2008-212397 proposes one of the countermeasure structures to solve this problem. Herein, the side frame is configured so that its upper portion is slender to avoid an overlap of the passenger's chest portion with the side frame in a vehicle side view when the passenger is seated. Further, the U-shaped bar member (see the wire member) is provided at the side frame so as to project forward so that the passenger seated in the seat can be held by this bar member in the vehicle width direction at the normal state, and that the impact acting on the vehicle side face can be absorbed at the vehicle side collision.

However, the above-described structure has another problem in that the holding power of the passenger may be insufficient because of the slender upper portion of the side frame and two-part members of the side frame (two members of the side frame and the bar member) may make the structure complex and increase the number of parts and assembling steps.

Meanwhile, Japanese Utility Model Laid-Open Publication No. 5-70345 discloses the back frame to absorb the impact load properly at the vehicle collision. Herein, the back frame has the side frames which are arranged on both sides of the back frame, and convex notches are formed at front and rear portions of the side frame so as to extend over an entire width of the side frame. The impact load can be absorbed by the notches. According to this structure, however, even though the impact load at the vehicle frontal or rear collision can be absorbed, it may be impossible that the impact load at the vehicle side collision is absorbed.

Further, Japanese Patent Laid-Open Publication No. 2006-110221 discloses the seat structure of a vehicle equipped with the side frame, in which the support pad, which may be made from a synthetic resin, such as hard polyurethane foam, is attached to the front side of the side frame. This support pad extends vertically from a position facing to a shoulder portion of the passenger seated to a position facing to a waist portion of the passenger, and its lower portion facing to the passenger's waist portion projects forward from its upper portion. According to this structure, the holing of the passenger seated in the seat can be improved by the support pad, but it may not be properly prevented by the support pad that the side frame comes toward the passenger at the vehicle side collision.

Moreover, Japanese Patent Laid-Open Publication No. 2000-125988 discloses the structure in which the seatback has the side support portion to support the passenger seated in the seat from the vehicle side, and the energy-absorbing pad is arranged inside the side support portion so as to absorb the impact at the vehicle side collision. However, this energy-absorbing pad is provided on the vehicle-outside of the side frame in the vehicle width direction, so any idea of preventing the side frame from coming toward the passenger by the energy-absorbing pad is not disclosed in the above-described publication.

### SUMMARY OF THE INVENTION

An object of the present invention is to provide a seat structure of a vehicle which can reduce the impact load from the vehicle side portion at the vehicle side collision and thereby properly decrease the load inputting to the passenger's chest portion.

According to the present invention, there is provided a seat structure of a vehicle, comprising a seatback frame provided on a vehicle-inside of a seatback (i.e., on an inside of a seatback in a vehicle width direction) which is provided at a rear portion of a seat cushion of a seat and supports a back of a passenger seated in the seat, a side frame extending vertically beside the seatback frame, and a pad member covering the side frame, the pad member forming a shape of the seatback, wherein an impact reduction structure to reduce an impact from a vehicle side is provided.

According to the present invention, since the impact reduction structure is provided, the impact load from the vehicle side portion at the vehicle side collision can be reduced, so that the load inputting to the passenger's chest portion can be decreased.

According to an embodiment of the present invention, an impact reduction portion to reduce the impact from the vehicle side is provided at the side frame, which constitutes the impact reduction structure. Herein, the impact reduction portion may be formed by a weak portion, thin portion, opening portion, rigidity-reducing portion or any other portion which causes deformation or split of the side frame at the vehicle side collision. Thereby, since the impact reduction portion is provided at the side frame itself, the above-described effect of the present invention can be properly obtained without making the structure complex or increasing the number of parts and manufacturing steps.

According to another embodiment of the present invention, the impact reduction portion causes deformation of the side frame by the impact from the vehicle side. Thereby, the load inputting to the passenger's chest portion can be properly decreased. Further, since the side frame deforms inside the pad member, the hardness of the side frame can be properly reduced with the pad member. Accordingly, the reduction of the impact load acting on the passenger at the vehicle side collision can be properly achieved.

According to another embodiment of the present invention, the impact reduction portion comprises a weak portion which is formed at the side frame so as to extend vertically, the weak portion being deformable by the impact from the vehicle side. Herein, the weak portion may be comprised of a thin portion, an opening portion, such as a slot, or the like. Thereby, since the weak portion as the impact reduction portion extends vertically, the deformation of the side frame is caused by the weak portion easily, so that the reduction of the inputted load to the passenger's chest portion can be properly achieved.

According to another embodiment of the present invention, the weak portion comprises a thin portion formed at the side frame. The thin portion can be easily formed by pressing concurrently with forming the side frame.

According to another embodiment of the present invention, another weak portion is further formed so as to extend continuously from the weak portion toward a front end portion of the side frame. Thereby, both the weak portion extending vertically and the weak portion formed at the front end portion of the side frame can cause the split of a specified portion of the side frame which may give the impact to the passenger at the vehicle side collision off a frame body of the side frame. Thus, this specified portion of the side frame may not be restrained by the pad member, so that the impact which the side frame may give to the passenger can be reduced.

According to another embodiment of the present invention, the impact reduction portion is formed at a position which corresponds to a chest portion of the passenger seated in the seat. Thereby, the side frame is made deform or split properly at the position corresponding to the passenger's chest portion, so that the impact given to the passenger's chest portion can be reduced. Accordingly, the pressing of the chest portion of the passenger can be reduced.

According to another embodiment of the present invention, a side airbag device with an airbag which is inflatable beside the passenger when a specified condition is satisfied is attached to the side frame, and an inflator to supply gas for the airbag is arranged at a specified position which is rearward from the impact reduction portion. Herein, the satisfaction of the specified condition may be determined by checking whether the lateral acceleration inputted from the vehicle side exceeds a specified value or not. The inflator is arranged at the specified position which is rearward from the impact reduction portion (where the inflator does not deform), so that the stable inflation of the airbag of the airbag device at the vehicle side collision can be obtained. Further, since the inflator which is a rigidity member is positioned in back of the impact reduction portion which deforms with the impact, any excessive load may not be given to the passenger by the inflator.

According to another embodiment of the present invention, the impact reduction portion is provided in back of a passenger-sitting front face of the seatback. Herein, the above-described passenger-sitting front face of the seatback means the front face of the seatback in a state in which the passenger seated leans against the seatback and thereby the pad member has been compressed to a certain degree so that the position of the front face of the seatback moves rearward from its normal position by the certain degree. Thereby, since the impact reduction portion is provided in back of the above-described passenger-sitting front face of the seatback, the impact which the passenger may receive from the deforming side frame at the vehicle side collision can be reduced.

According to another embodiment of the present invention, the seat structure of a vehicle further comprising a side support portion which is provided at the seatback so as to support the seated passenger from the vehicle side, wherein the side frame is arranged in back of a passenger-sitting front face of the seatback at a position which corresponds to a chest portion of the passenger seated in the seat, not so as to extend forward beyond the passenger-sitting front face of the seatback, in a plan view and another hard pad member than the pad member is arranged inside the side support portion at a specified position which is located on a vehicle-inside of the side frame, which constitutes the impact reduction structure. Herein, the above-described hard pad member may be made from a hard urethane material. Thereby, since the side frame is arranged in back of the passenger-sitting front face of the seatback, not so as to extend forward beyond the passenger-sitting front face of the seatback, in the plan view, the upper portion of the side frame can be formed to be properly slender. Accordingly, it can be avoided that the side frame contacts the passenger. Further, the passenger can be properly supported from the vehicle side by the pad member arranged along the inward side of the side frame at the normal state. Moreover, since the side frame does not exist at a position in front of the passenger-sitting front face of the seatback, no any particular problem occurs at the vehicle side collision. Further, even if the side frame deforms inward in the vehicle width direction at the vehicle side collision, this deformation may be received by the hard pad member, so that the safety of the passenger can be improved.

Other features, aspects, and advantages of the present invention will become apparent from the following description which refers to the accompanying drawings.

### BRIEF DESCRIPTION OF THE DRAWINGS

FIG. 1 is a schematic side view showing a seat structure of a vehicle according to a first embodiment of the present invention.

FIG. 2 is a sectional view taken along line A-A of FIG. 1.

FIG. 3 is a side view of a side frame.

FIG. 4 is a sectional view taken along line B-B of FIG. 3.

FIGS. 5A-5D are sectional views showing structures of a weak portion.

FIG. 6 is an explanatory diagram showing a deformation state of the side frame at a vehicle side collision.

FIG. 7 is a side view showing another forming pattern of an impact reduction portion according to a second embodiment.

FIG. 8 is a side view showing another impact reduction portion using a slot according to a third embodiment.

FIG. 9 is a sectional view showing a seat structure of a vehicle equipped with a side airbag device according to a fourth embodiment.

FIG. 10 is a side view of a major part of FIG. 9.

FIG. 11 is an explanatory diagram at an airbag inflation.

FIG. 12 is a side view showing a modification of an inflator arrangement structure.

FIG. 13 is a sectional view showing a fifth embodiment in which an inflator is arranged on the vehicle-inside of the side frame.

FIG. 14 is an explanatory diagram at the airbag inflation.

FIG. 15 is a sectional view showing another impact reduction portion according to a sixth embodiment.

FIG. 16 is a sectional view showing a modification of the above-described impact reduction portion.

FIG. 17 is a sectional view showing another seat structure of a vehicle according to a seventh embodiment.

FIG. 18 is a sectional view showing a modification of the above-described seat structure of a vehicle.

### DETAILED DESCRIPTION OF THE INVENTION

Hereinafter, preferred embodiments of the present invention will be described referring to the accompanying drawings.

### Embodiment 1

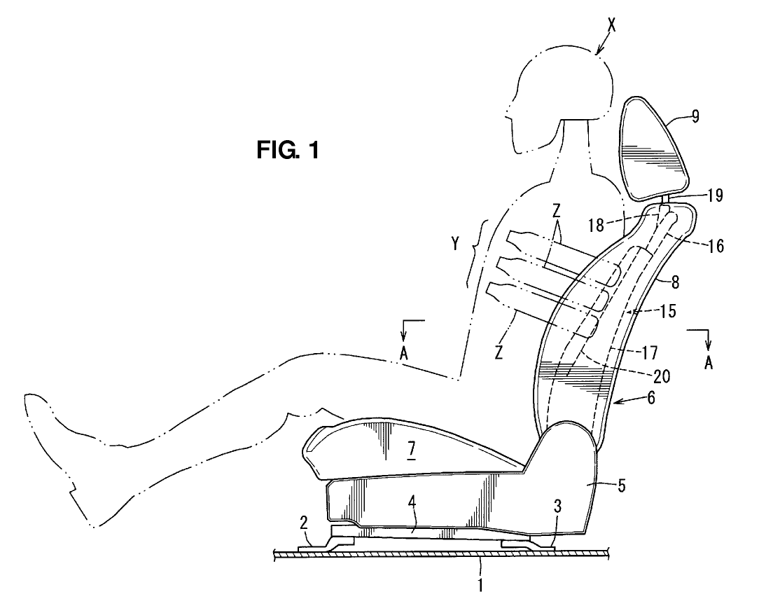

A first embodiment of the present invention will be described referring to FIGS. 1-6. The figures show a seat structure of a vehicle. In a schematic side view of FIG. 1, a seat slide rail 4 is provided on a floor panel 1 via plural seat attaching brackets 2, 3.

The seat slide rail 4 comprises a fixed lower rail and a movable upper rail, and a seat 6 is provided at the upper rail via a seat cushion frame 5. This seat 6 may be any one of a front seat, such as a driver's seat or a passenger's seat, a second-row rear seat, or a third-row rear seat, and the seat arranged on the left is shown in the present embodiment.

The seat 6 comprises a seat cushion 7 which forms a sitting face for a passenger, a seatback 8 which is connected to a rear portion of the seat cushion 7 and supports a back of the passenger seated in the seat 6 from behind, and a headrest 9 which is provided at an upper portion of the seatback 8 and supports a head of the passenger seated in the seat 6 from behind. Herein, a manikin (a so-called dummy) X is illustrated as the passenger in the figures, which comprises its chest portion X and its ribs Z.

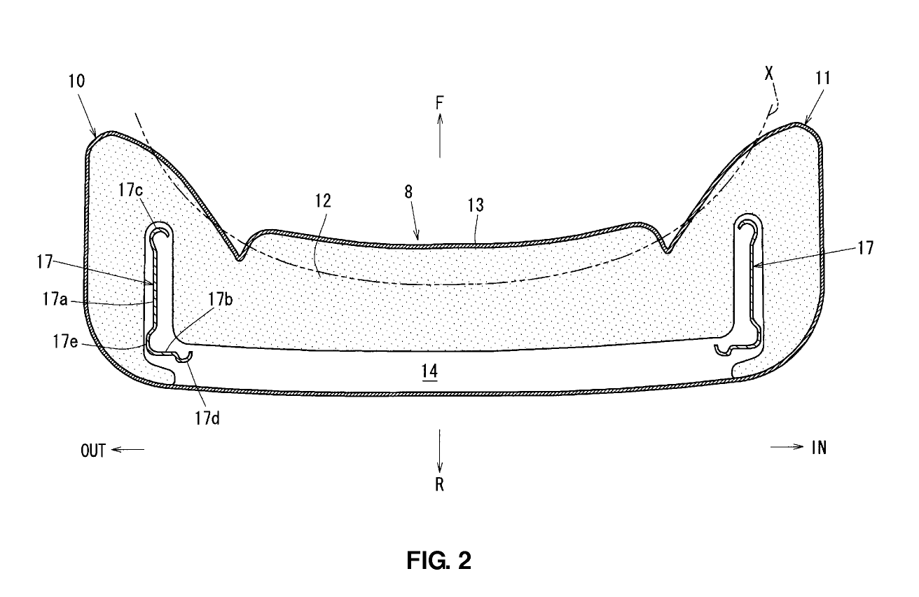

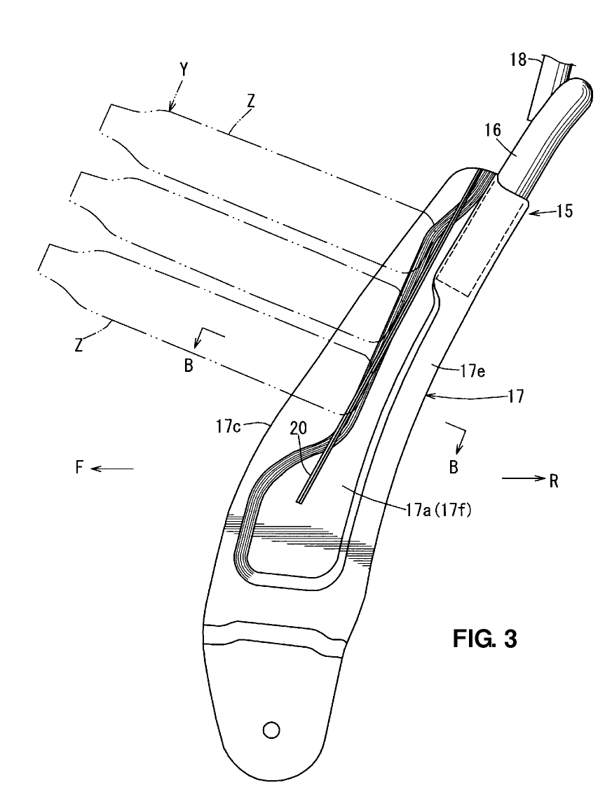

FIG. 2 is a sectional view (plan view) taken along line A-A of FIG. 1, and FIG. 3 is a side view of a major part in a state in which FIG. 2 is viewed from a vehicle outside. As shown in FIG. 2, the seatback 8 is equipped with a pair of left and right side support portions 10, 11 which supports the passenger (see the manikin X) seated in the seat 6 from the vehicle sides. Further, the seatback 8 comprises a pad member 12 which forms its shape and a surface 13 which covers over the pad member 12 from outside, and it also has a space 14 at its back portion where no pad member exits for the purpose of weight reduction.

As shown in FIGS. 2 and 3, a seatback frame 15 is provided on a vehicle-inside of the seatback 8, and this seatback frame 15 comprises a main frame 16 which is formed in a gate shape in an elevation view, and a pair of side frames 17, 17 which extends vertically on both sides of the main frame 16. Further, as shown in FIGS. 1 and 3, a pole guide 18 (a so-called support pipe) is provided at an upper portion of the main frame 16, and a headrest pole 19 of the headrest 9 is supported by the pole guide 18 so as to move vertically. The above-described side frames 17, 17 are covered with the pad member 12 as shown in FIG. 2.

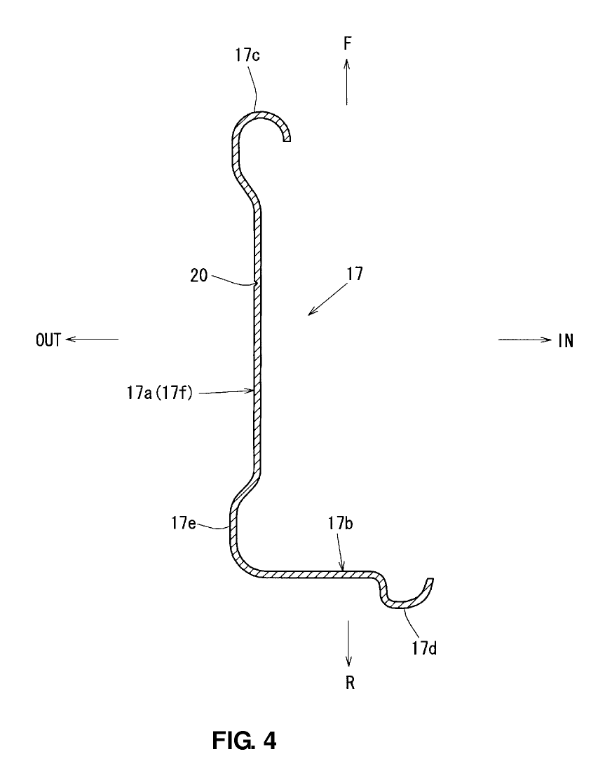

FIG. 4 is a sectional view taken along line B-B of FIG. 3, which shows a cross-section structure of the side frame 17. As shown in FIG. 4, the side frame 17 comprises a side portion 17a (including a front bead portion 17c and a projection portion 17e, which will be described later) which extends longitudinally, and a rear portion 17b (including a rear bead portion 17d, which will be described later), and this side frame 17 is formed in a L shape in a plan view. The front bead portion 17c is formed integrally at a front end of the side portion 17a and projects toward the both sides, i.e., inward and outward, in the vehicle width direction. The rear bead portion 17d is formed integrally at an inward end of the rear portion 17b and projects rearward. The projection portion 17e is formed integrally at a rear portion of the side portion 17a and projects outward.

In other words, as shown by the side view of FIG. 3, between the front bead portion 17c and the projection portion 17e is formed a concave portion 17f which extends vertically along the longitudinal direction of the side frame 17. The sufficient rigidity of the side frame 17 is ensured by forming this concave portion 17f.

Further, a weak portion 20, which is an example of the impact reduction portion to reduce the impact from the vehicle side, is formed at the side portion 17a of the side frame 17 so as to extend vertically as shown in FIG. 3.

As shown in FIG. 3, the weak portion 20 extends vertically from an upper end of the side portion 17a of the side frame 17 to a lower portion of the side portion 17a through a portion corresponding to the chest portion of the passenger seated in the seat 6, i.e., right behind the ribs Z of the manikin X shown by an imaginary line. This weak portion 20 causes a deformation of the side portion 17a of the side frame 17 by the impact (at the vehicle side collision) from the vehicle side, thereby reducing the impact. While the weak portion 20 shown in FIG. 3 extends linearly and continuously, it may be formed so as to extend substantially continuously having small vertical gaps. Further, the forming pattern of the weak portion 20 may not necessarily be linear. In the present embodiment, when the impact acts from the vehicle side, the above-described weak portion 20 causes the side portion 17a of the side frame 17 to deform outward or inward.

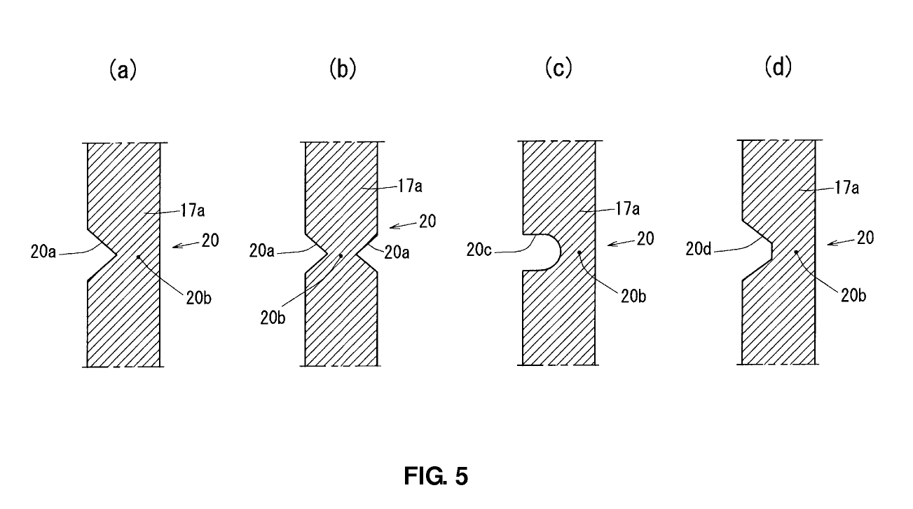

FIGS. 5A-5D are sectional views showing specific structures of the weak portion 20 shown in FIGS. 3 and 4. The weak portion 20 shown in FIG. 5A has a V-shaped concave portion 20a which is formed at one side of the side portion 17a, and thus a thin portion 20b of the side portion 17a constitutes the weak portion 20.

The weak portion 20 shown in FIG. 5B has V-shaped concave portion 20a, 20a which are formed at both sides of the side portion 17a, and thus a thin portion 20b of the side portion 17a constitutes the weak portion 20.

The weak portion 20 shown in FIG. 5C has a U-shaped concave portion 20c which is formed at one side of the side portion 17a, and thus a thin portion 20b of the side portion 17a constitutes the weak portion 20.

The weak portion 20 shown in FIG. 5D has a reverse-trapezoid-shaped concave portion 20d which is formed at one side of the side portion 17a, and thus a thin portion 20b of the side portion 17a constitutes the weak portion 20.

Any other modifications of the weak portion 20 shown in FIGS. 5A-5D may be applied. For example, the concave portions 20c, 20d shown in FIGS. 5C, 5D may be formed at the both sides. Further, the longitudinal length of the thin portion 20b may be longer by prolonging the top portion of the trapezoid of the concave portion 20d shown in FIG. 5D.

Any one of the structures shown in FIGS. 5A-5D is selected as the weak portion 20. While a pair of right and loft side frames 17, 17 is arranged on both sides of the seatback 8 as shown in FIG. 2, it is enough that the weak portion 20 is formed only at the outside-located side frame 17. Of course, the weak portion 20 may be formed at the both side frames 17, 17 and the seat 6 may be installed on the left side or the right side. In the figures, an arrow F shows a forward direction of the vehicle, an arrow R shows a rearward direction of the vehicle, an arrow OUT shows an outward direction of the vehicle, and an arrow IN shows an inward direction of the vehicle.

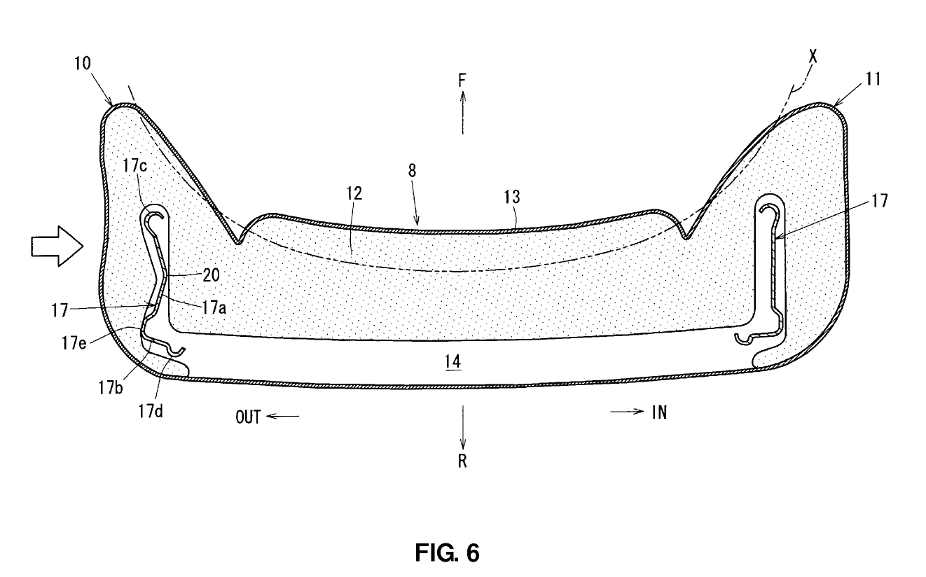

According to the seat structure of the vehicle described above, when the impact is inputted to the seat 6 from the vehicle side at the vehicle side collision, the weak portion 20 causes the deformation of the side portion 17a of the side frame 17 as shown in FIG. 6, so that the impact load is reduced and thereby the load inputted to the chest portion of the passenger can be decreased.

As described above, the seat structure of a vehicle according to the first embodiment shown in FIGS. 1-6 comprises the seatback frame 15 provided on the vehicle-inside of the seatback 8 which is provided at the rear portion of the seat cushion 7 of the seat 6 and supports the back of the passenger (see the manikin X) seated in the seat 6, the side frame 17 extending vertically beside the seatback frame 15, and the pad member 12 covering the side frame 17, the pad member 12 forming the shape of the seatback 8, wherein the impact reduction portion (see the weak portion 20) to reduce the impact from the vehicle side is provided at the side frame 17 (see FIGS. 1, 2 and 3).

According to this structure, since the impact reduction portion (see the weak portion 20) is provided at the side frame 17 itself, the impact load from the vehicle side portion at the vehicle side collision can be reduced by the impact reduction portion (see the weak portion 20), so that the load inputting to the passenger's chest portion can be decreased. Further, the above-described effect can be obtained without making the structure complex or increasing the number of parts and manufacturing steps.

Further, the impact reduction portion (see the weak portion 20) causes the deformation of the side frame 17 by the impact from the vehicle side (see FIG. 6). Thereby, the load inputting to the passenger's chest portion can be properly decreased.

Moreover, since the side frame 17 deforms inside the pad member 12, the hardness of the side frame 17 can be properly reduced with the pad member 12. Accordingly, the reduction of the impact load acting on the passenger at the vehicle side collision can be properly achieved.

Additionally, the impact reduction portion comprises the weak portion 20 which is formed at the side frame 17 so as to extend vertically, the weak portion 20 being deformable by the impact from the vehicle side (see FIGS. 3 and 6). Thereby, since the weak portion 20 of the impact reduction portion extends vertically, the deformation of the side frame 17 (especially, the side portion 17a) is caused by the weak portion 20 easily, so that the reduction of the inputted load to the passenger's chest portion can be properly achieved.

Further, the weak portion 20 comprises the thin portion 20b which is formed at the side frame 17 (see FIGS. 4 and 5). The thin portion 20b can be easily formed by pressing concurrently with forming the side frame 17.

Moreover, the impact reduction portion (see the weak portion 20) is formed at the position which corresponds to the chest portion (see the chest portion Y of the manikin X by the imaginary line in FIG. 3) of the passenger seated in the seat 6 (see FIG. 3). Thereby, the side frame 17 is made deform or split properly (“deform” in case of the first embodiment) at the position corresponding to the passenger's chest portion Y, so that the impact given to the passenger's chest portion Y can be reduced. Accordingly, the pressing of the chest portion Y of the passenger can be reduced.

### Embodiment 2

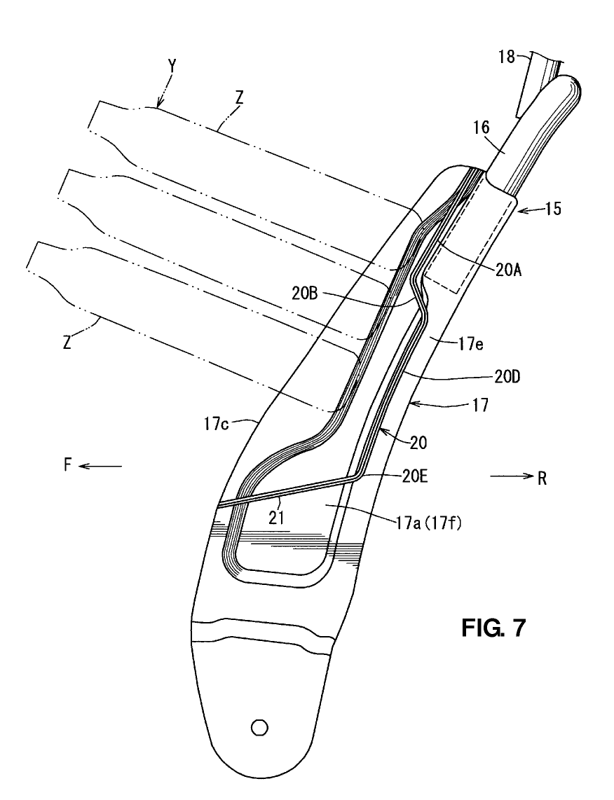

FIG. 7 shows another embodiment of the seat structure of a vehicle, in which another weak portion 21 is further formed so as to extend continuously from the above-described weak portion 20 toward a front end portion of the side portion 17a of the side frame 17. That is, the above-described weak portion 20 comprises, at a position where the main frame 16 and sub frame 17 do not overlap with each other in the vehicle width direction, an upper portion 20A which extends downward from the upper end of the side portion 17a to a lower portion corresponding to the lower end of the main frame 16, a middle portion 20B which extends obliquely downward and rearward from the lower end of the upper portion 20A, and a lower portion 20D which extends downward from the lower end of the middle portion 20B along the front side of the projection portion 17e.

Further, another weak portion 21 is further formed so as to extend from a lower end 20E of the above-described weak portion 20 toward the front end portion of the side portion 17a of the side frame 17. Thus, the weak portion 20 and the additional weak portion 21 are made completely continuous from each other. Herein, the additional weak portion 21 is also continuous from the front bead portion 17c for the purpose of splitting a front-side portion from the respective weak portions 20, 21 at the vehicle side collision.

As described above, in the second embodiment shown in FIG. 7, the weak portion 21 is further formed so as to extend continuously from the above-described weak portion 20 toward the front end portion of the side frame 17 (see FIG. 7). Thereby, both the weak portion 20 extending vertically and the weak portion 21 formed at the front end portion of the side frame 17 can cause the split of the specified portion of the side frame 17 which may give the impact to the passenger at the vehicle side collision off a frame body of the side frame 17. Thus, this specified portion of the side frame 17 may not be restrained by the pad member, so that the impact which the side frame 17 may give to the passenger can be reduced.

The other structures, operations and effects of the present embodiment are substantially the same as those of the above-described first embodiment, so the same portions as the first embodiment are denoted by the same reference characters in FIG. 7, specific descriptions of which are omitted here. The forming pattern of the weak portions 20, 21 should not be limited to the ones shown in FIG. 7 as long as they are formed so as to be continuous from the upper end of the side portion 17a of the side frame 17 to the front end of the side portion 17a through the position corresponding to the chest portion of the passenger seated in the seat (the position behind the ribs Z of the manikin X).

### Embodiment 3

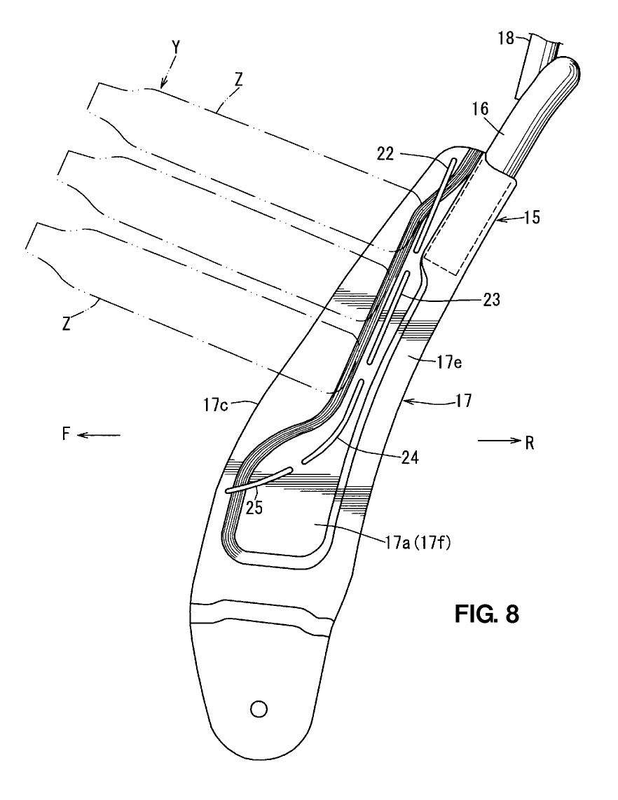

FIG. 8 shows further another embodiment of the seat structure of a vehicle, in which the impact reduction portion comprises plural slots 22, 23, 24, 25. That is, the plural slots 22-25 as the impact reduction portion to reduce the impact from the vehicle side are formed at the side portion 17a of the side frame 17. The slots 22-25 cause the deformation of the side portion 17a of the side frame 17 by the impact from the vehicle side, so that the impact can be reduced.

In the third embodiment, the first slot 22, the second slot 23 and an upper portion of the third slot 24 are formed at the side portion 17a of the side frame 17 so as to extend vertically, a lower portion of the third slot 24 and the fourth slot 25 are formed in an arc shape, and the fourth slot 25 is formed so as to be positioned on an extension line of the third slot 24 and its lower end extends to near the front end of the side portion 17a.

These slots 22-25 (opening portions) are formed so that the side portion 17a of the side frame 17 exists between the adjacent slots (22 and 23, 23 and 24, 24 and 25), respectively. Thereby, the necessary rigidity of the side frame 7 at the normal state is ensured. That is, in the third embodiment, the first slot 22, the second slot 23 and the upper portion of the third slot 24 constitute the weak portion extending vertically at the side frame 17, and the lower portion of the third slot 24 and the fourth slot 25 constitute the other weak portion extending continuously from the above-described weak portion toward the front end portion of the side frame 17.

According to the seat structure of the vehicle described above, when the impact is inputted to the seat 6 from the vehicle side at the vehicle side collision, the slots 22, 23, 24, 25 as the impact reduction portion cause the deformation of the side portion 17a of the side frame 17, so that the impact load is reduced and thereby the load inputted to the chest portion of the passenger can be decreased.

The other structures, operations and effects of the third embodiment are substantially the same as those of the above-described embodiments, so the same portions as the previous embodiments are denoted by the same reference characters in FIG. 8, specific descriptions of which are omitted here. The forming pattern of the slots 22-25 should not be limited to the one shown in FIG. 7 as long as the slots are formed so as to extend from the upper end of the side portion 17a of the side frame 17 to the front end of the side portion 17a through the position corresponding to the chest portion of the passenger seated (the position behind the ribs Z of the manikin X). Further, the length or the number of the slots 22-25 should not be limited to the ones shown in FIG. 8, and the number of the slots may be three, or five or more.

### Embodiment 4

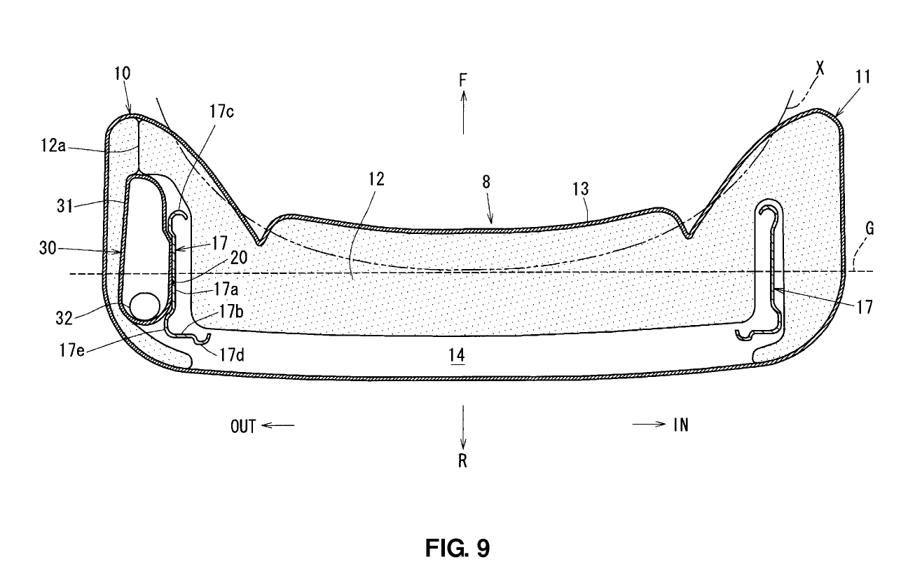

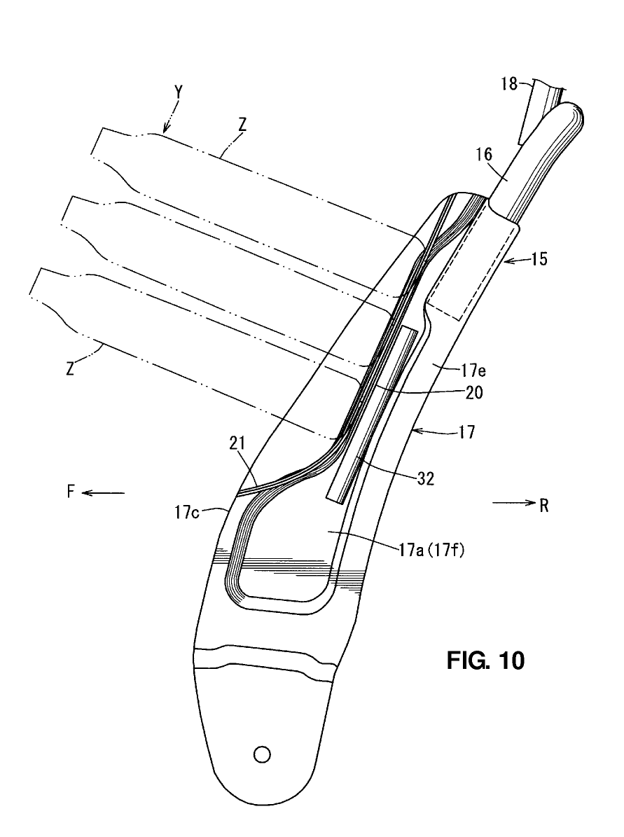

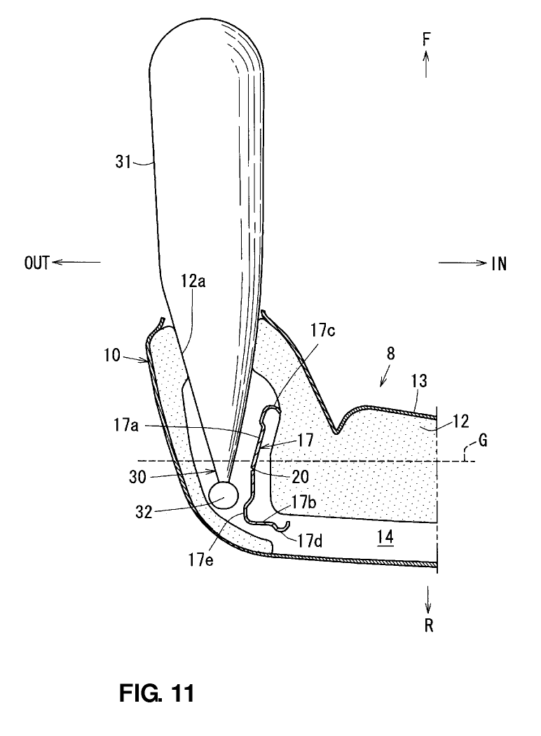

FIGS. 9, 10 and 11 show further another embodiment of the seat structure of a vehicle, and FIG. 9 is a plan view, FIG. 10 is a side view of its major part, and FIG. 11 is an explanatory diagram at the airbag inflation. In the fourth embodiment, as shown in FIG. 9, a side airbag device 30 is provided on a vehicle-outside of the side portion 17a of the side frame 17 (i.e., on an outside of the side portion 17a of the side frame in the vehicle width direction).

The side airbag device 30 comprises an airbag 31 which is inflatable beside the passenger when a specified condition is satisfied (for example, a lateral acceleration inputted from the vehicle side exceeds a specified value), and an inflator 32 to supply gas for the airbag 31. The side airbag device 30 is attached to the side frame 17, and the airbag 31 is stored inside on the vehicle-outside of the side portion 17a over the side support portion 10. Further, a slit 12a is formed at a specified portion of the pad member 12 which corresponds to the side of the passenger so that the airbag 31 can inflate forward from the front portion of the side support portion 10 beside the passenger (see FIG. 11).

A specific illustration of the folding structure of the airbag 31 is omitted and the airbag 31 is schematically illustrated in FIG. 9. In FIG. 9, a reference character G denotes a passenger-sitting front face of the seatback 8 (a front face of the seatback 8 in a state in which the passenger leans against the seatback 8 and thereby the pad member 12 has been compressed to a certain degree), and the impact reduction portion 20 as the impact reduction portion is provided in back of the passenger-sitting front face G.

The above-described inflator 32 is arranged at a specified position which is rearward from the weak portion 20 as the impact reduction portion. That is, the inflator 32 is provided at the position where the inflator 32 does not deform at the vehicle side collision. Further, the inflator 32 is provided at the height position which corresponds to the middle portion of the side portion 17a of the side frame 17 as shown in FIG. 10.

According to the seat structure of the vehicle described above, when the impact is inputted to the seat 6 from the vehicle side at the vehicle side collision, the gas is supplied into the airbag 31 according to the operation of the inflator 32, so that the airbag 31 comes out of the slit 12a of the side support portion 10 and inflates beside the passenger seated in the seat 6 as shown in FIG. 11. The inflation pressure of the airbag 31 makes the weak portion 20 as the impact reduction portion cause the inward deformation of the side portion 17a of the side frame 17. This deformation of the side portion 17a reduces the impact load, so that the load inputted to the chest portion of the passenger can be decreased.

According to the present embodiment shown in FIGS. 9, 10 and 11, the side airbag device 30 with the airbag 31 which is inflatable beside the passenger when the specified condition is satisfied is attached to the side frame 17, and the inflator 32 to supply the gas for the airbag 31 is arranged at the specified position which is rearward from the impact reduction portion (see the weak portion 20) (see FIG. 9). Thus, the inflator 32 is arranged at the specified position which is rearward from the impact reduction portion (see the weak portion 20), so that the stable inflation of the airbag 31 of the airbag device 30 at the vehicle side collision can be obtained.

Further, since the inflator 32 which is a rigidity member is positioned in back of the impact reduction portion (see the weak portion 20) which deforms with the impact, any excessive load may not be given to the passenger by the inflator 32.

Further, the impact reduction portion (see the weak portion 20) is provided in back of the passenger-sitting front face G of the seatback 8 (see FIG. 9). Thereby, the impact which the passenger may receive from the deforming side frame 17 at the vehicle side collision can be reduced.

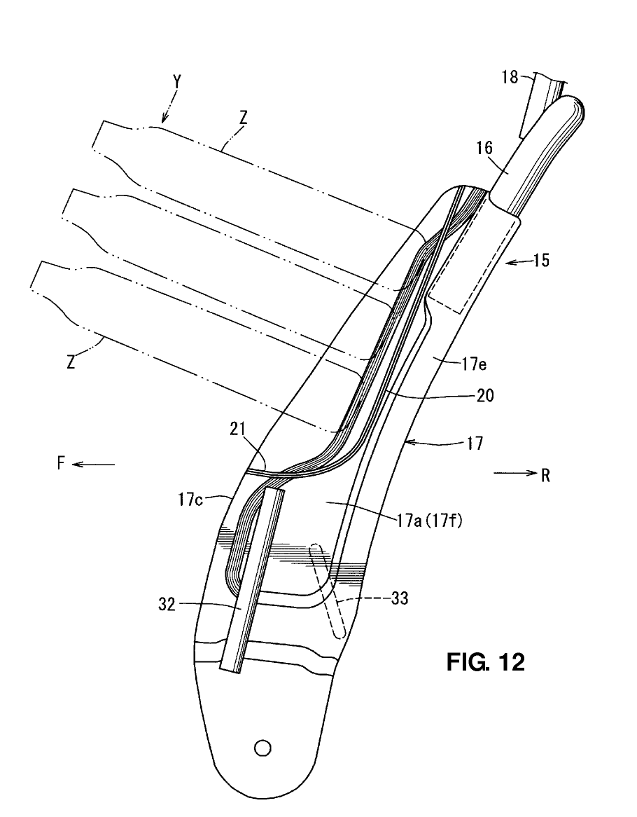

The other structures, operations and effects of the fourth embodiment shown in FIGS. 9-11 are substantially the same as those of the above-described embodiments, so the same portions as the previous embodiments are denoted by the same reference characters in FIGS. 9-11, specific descriptions of which are omitted here. A structure shown in FIG. 12 may be applied in place of the structure shown in FIG. 10. That is, the inflator 32 is arranged at the specified portion of the side portion 17a of the side frame 17 which corresponds to the chest portion of the passenger in FIG. 10, but in a modification shown in FIG. 12, the inflator 32 is arranged at a specified portion in front of the side portion 17a of the side frame 17 which corresponds to the waist portion of the passenger, and a lumber support lever 33 is arranged at a portion of the side portion 17a in back of the inflator 32 so as to be apart from the inflator 32.

Further, as shown in FIG. 12, the side portion 17a of the side frame 17 is configured to be split into a front part and a rear part due to the weak portions 20, 21 at the vehicle side collision, and its front part is arranged in a split area, and its rear part, including its lower part, is arranged in a nun-split area (non-deformation area) where the inflator 32 and the lumber support 33 are provided. The inflator 32 is attached to a position below the weak portion 21 which corresponds to the waist portion of the passenger.

Thus, since the inflator 32 is attached to the position corresponding to the waist portion of the passenger, it can be prevented that the chest portion of the passenger is hurt by the inflator 32 at the vehicle side collision, and the layout of the inflator 32 and the lumber support lever 33 can be provided, ensuring the front arrangement of the inflator 32. The other structures, operations and effects of the present embodiment are substantially the same as those of the above-described embodiment shown in FIGS. 9-11, so the same portions as the previous embodiments are denoted by the same reference characters in FIG. 12, specific descriptions of which are omitted here.

### Embodiment 5

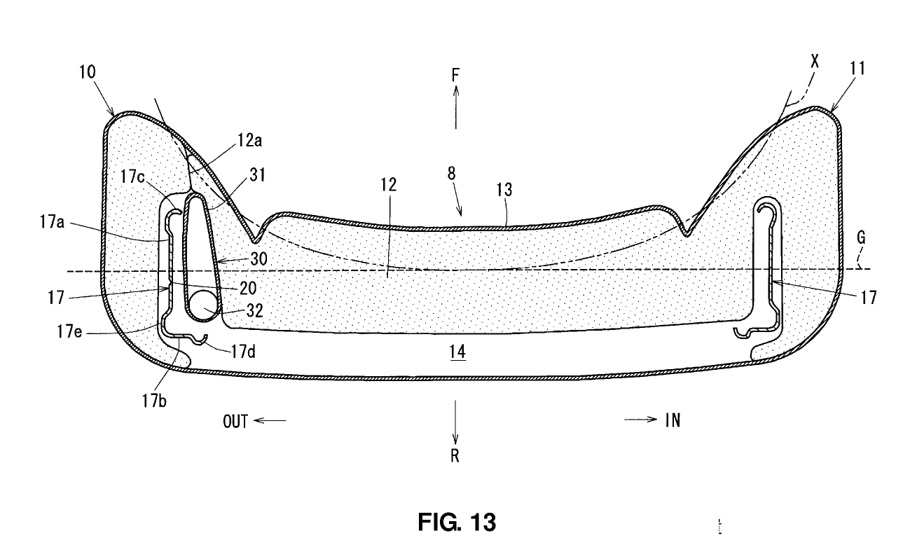

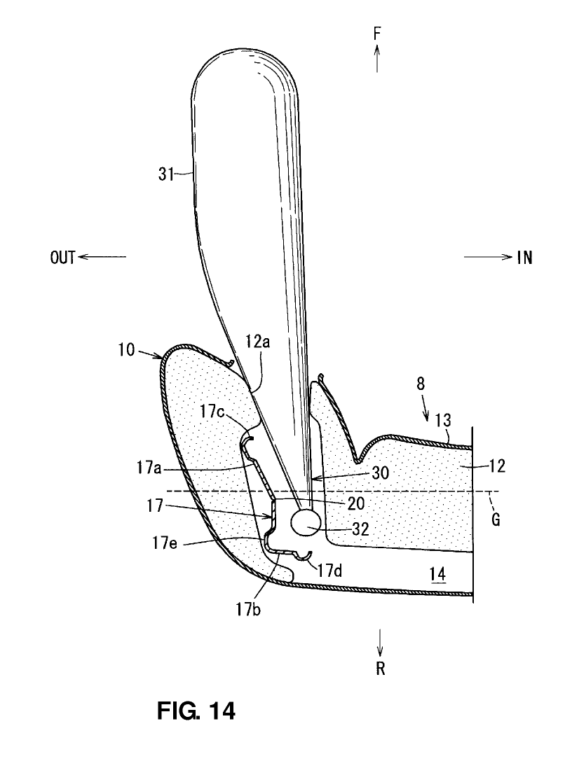

FIGS. 13 and 14 show further another embodiment of the seat structure of a vehicle, and FIG. 13 is a plan view, and FIG. 14 is an explanatory diagram at an airbag inflation. In the fifth embodiment, as shown in FIG. 13, the side airbag device 30 is provided on the vehicle-inside of the side portion 17a of the side frame 17.

The side airbag device 30 comprises the airbag 31 which is inflatable beside the passenger when a specified condition is satisfied (for example, the lateral acceleration inputted from the vehicle side exceeds a specified value), and the inflator 32 to supply the gas for the airbag 31.

The side airbag device 30 is attached to the side frame 17, and the airbag 31 is stored inside on the vehicle-inside of the side portion 17a over the side support portion 10. Further, the slit 12a is formed at a specified portion of the pad member 12 which corresponds to the side of the passenger so that the airbag 31 can inflate forward from the front portion of the side support portion 10 beside the passenger (see FIG. 14). A specific illustration of the folding structure of the airbag 31 is omitted and the airbag 31 is schematically illustrated in FIG. 13. In FIG. 13, the reference character G denotes the passenger-sitting front face of the seatback 8, and the impact reduction portion 20 as the impact reduction portion is provided in back of the passenger-sitting front face G.

The above-described inflator 32 is arranged at a specified position which is rearward from the weak portion 20 as the impact reduction portion. That is, the inflator 32 is provided at the position where the inflator 32 does not deform at the vehicle side collision. Herein, the arrangement position of the inflator 32 in the vertical direction is the same as the position shown in FIG. 10, but the inflator 32 may be arranged at the height position shown in FIG. 12.

According to the seat structure of the vehicle described above, when the impact is inputted to the seat 6 from the vehicle side at the vehicle side collision, the gas is supplied into the airbag 31 according to the operation of the inflator 32, so that the airbag 31 comes out of the slit 12a of the side support portion 10 and inflates beside the passenger seated in the seat 6 as shown in FIG. 14. The inflation pressure of the airbag 31 makes the weak portion 20 as the impact reduction portion cause the outward deformation of the side portion 17a of the side frame 17. This deformation of the side portion 17a reduces the impact load, so that the load inputted to the chest portion of the passenger can be decreased.

According to the present embodiment shown in FIGS. 13 and 14, the side airbag device 30 with the airbag 31 which is inflatable beside the passenger when the specified condition is satisfied is attached to the side frame 17, and the inflator 32 to supply the gas for the airbag 31 is arranged at the specified position which is rearward from the impact reduction portion (see the weak portion 20) (see FIG. 13). Thus, the inflator 32 is arranged at the specified position which is rearward from the impact reduction portion (see the weak portion 20), so that the stable inflation of the airbag 31 of the airbag device 30 at the vehicle side collision can be obtained.

Further, since the inflator 32 which is the rigidity member is positioned in back of the impact reduction portion (see the weak portion 20) which deforms with the impact, the passenger is not hurt by the inflator 32. Further, the impact reduction portion (see the weak portion 20) is provided in back of the passenger-sitting front face G of the seatback 8 (see FIG. 13).

Thereby, since the impact reduction portion (see the weak portion 20) is provided in back of the passenger-sitting front face G, the impact which the passenger may receive from the deforming side frame 17 at the vehicle side collision can be reduced. The other structures, operations and effects of the fifth embodiment shown in FIGS. 13 and 14 are substantially the same as those of the above-described fourth embodiment, so the same portions as the previous embodiments are denoted by the same reference characters in FIGS. 13 and 14, specific descriptions of which are omitted here.

### Embodiment 6

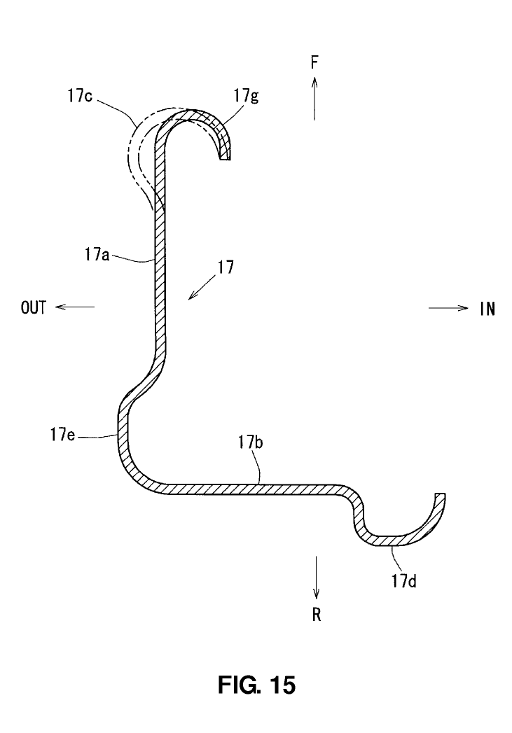

FIG. 15 shows another embodiment of the side frame 17. While the weak portion 20, such as the thin portion, is used as the impact reduction portion in the embodiments shown in FIGS. 3, 7, 10, 12 and 13 and the plural slots 22-25 are used as the impact reduction portion in the embodiment shown in FIG. 8, the side frame 17 is configured so that its rigidity portion is formed in a non-rigidity structure in the present embodiment shown in FIG. 15. That is, a low-rigidity curve portion (half circular portion) 17g is formed in place of the high-rigidity front bead portion 17c shown by the imaginary line. This curve portion 17g is formed so as not to project outward from the side portion 17a as shown, and this portion 17g has a low rigidity and thereby functions as the impact reduction portion.

As shown in FIG. 15, in case the above-described side frame 17 equipped with the low-rigidity curve portion 17g is installed to the seatback 8 shown in FIG. 2, for example, the low-rigidity curve portion 17g absorbs the impact load from the vehicle side at the vehicle side collision by deforming, so that the load inputted to the chest portion of the passenger can be reduced. Herein, the vertical range where the above-described curve portion 17g is basically set to an area which only corresponds to the chest portion of the passenger seated in the seat, but that may be set to an entire height area of the side frame 17, considering easy manufacturing of the side frame 17.

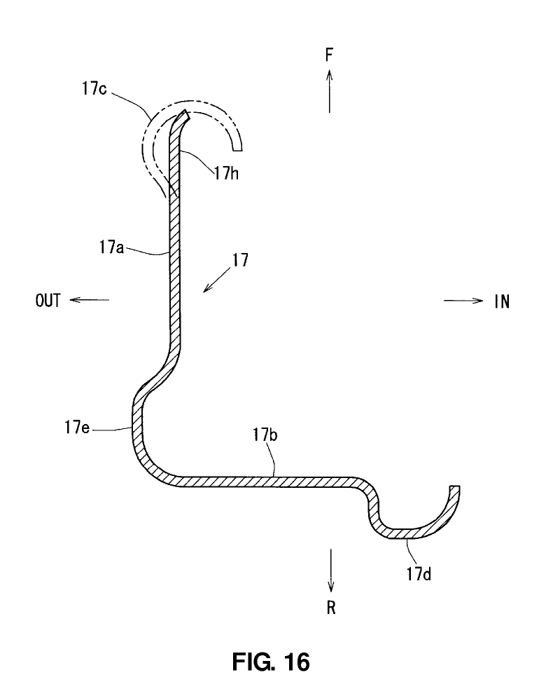

Further, in place of the structure shown in FIG. 15, a modification of the side frame 17 is shown in FIG. 16. Herein, the modified side frame 17 is configured so that its rigidity portion is formed in the non-rigidity structure as well. That is, a low-rigidity substantially-straight portion 17h is formed in place of the high-rigidity front bead portion 17c shown by the imaginary line in FIG. 16. This substantially-straight portion 17h is formed so as to extend almost on an extension line of the side portion 17a as shown, and this portion 17h has the low rigidity and thereby functions as the impact reduction portion as well.

As shown in FIG. 16, in case this side frame 17 equipped with the low-rigidity substantially-straight portion 17h is installed to the seatback 8 shown in FIG. 2, for example, the low-rigidity substantially-straight portion 17h absorbs the impact load from the vehicle side at the vehicle side collision by deforming, so that the load inputted to the chest portion of the passenger can be reduced. Herein, the vertical range where the above-described substantially-straight portion 17h is basically set to the area which only corresponds to the chest portion of the passenger seated in the seat like the above-described embodiment shown in FIG. 5, but that may be set to an entire height area of the side frame 17, considering the easy manufacturing of the side frame 17.

Herein, since the side frame 17 is equipped with the rear bead portion 17d and the projection portion 17e in these embodiments shown in FIGS. 15 and 16 as well, the minimum necessary rigidity of the side frame 17 can be ensured for the normal state (the vehicle non-collision state). The same portions shown in FIGS. 15 and 16 as the previous embodiment shown in FIG. 4 are denoted by the same reference characters, specific descriptions of which are omitted here.

### Embodiment 7

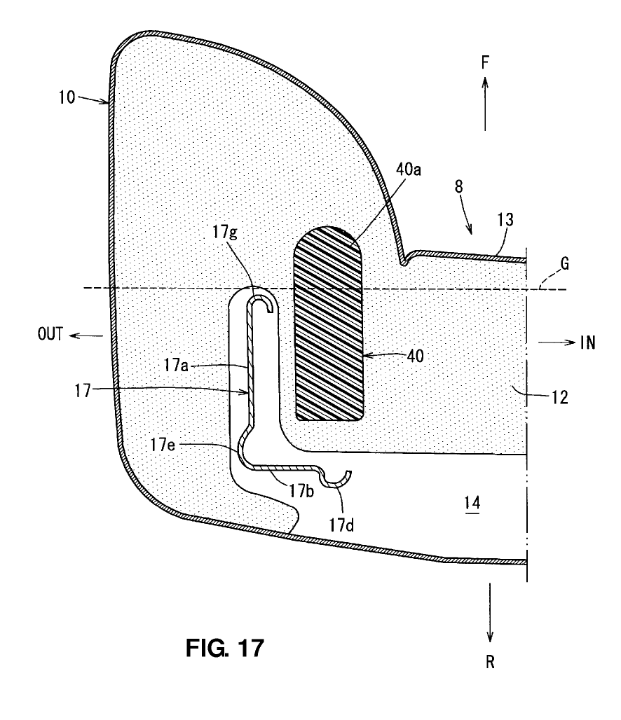

FIG. 17 is a sectional view showing further another embodiment of the seat structure of a vehicle. In the present embodiment, the seatback 8 comprises the side support portion 10 which supports the passenger seated in the seat 6 from the vehicle side, and the side frame 17 with the L-shaped cross section which has the side portion 17a and the rear portion 17b. The side frame 17 extends vertically beside the seatback frame 15.

The reference character G shows the passenger-sitting front face of the seatback 8 in FIG. 17, and the side frame 17 does not project forward from the passenger-sitting front face G inside the side support portion 10 in the plan view of the seat. That is, the side frame 17 is arranged in back of the above-described passenger-sitting front face G of the seatback 8.

Further, a hard pad member 40 as another impact reduction portion than the above-described pad member 12 is provided inside the side support portion 10 on the vehicle-inside of the side frame 17. This hard pad member 40, which may be made of a hard urethane material, is arranged so that its front portion 40a projects forward from the passenger-sitting front face G so as to support the passenger seated in the seat 6 from the vehicle side properly.

According to the seat structure of a vehicle described above, even when the impact is inputted to the seat 6 from the vehicle side at the vehicle side collision and thereby the side frame 17 deforms inward, the side frame 17 does not project forward from the passenger-sitting front face G, resulting in casing no problem in particular. Even if the side frame 17 deforms inward at the vehicle side collision, the side frame deforming can be received by the hard pad member 40. Accordingly, the safety of the passenger seated in the seat 6 can be ensured properly.

As described above, the seat structure of a vehicle according to the seventh embodiment shown in FIG. 17 further comprising the side support portion 10 which is provided at the seatback 8 so as to support the seated passenger from the vehicle side, wherein the side frame 17 is arranged in back of the passenger-sitting front face G of the seatback 8 at the position which corresponds to the chest portion of the passenger seated in the seat 6, not so as to extend forward beyond the passenger-sitting front face G of the seatback 8, in the plan view and another hard pad member 40 than the pad member 20 is arranged inside the side support portion 10 at the specified position which is located on the vehicle-inside of the side frame 17 (see FIG. 17 and the previous figure). Thereby, since the side frame 17 is arranged in back of the passenger-sitting front face G of the seatback 8, not so as to extend forward beyond the passenger-sitting front face G of the seatback 8, in the plan view of the seat (see FIG. 17), the upper portion of the side frame 17 can be formed to be properly slender. Accordingly, it can be avoided that the side frame 17 contacts the passenger.

Further, the passenger can be properly supported from the vehicle side by the hard pad member 40 (the front portion 40a, in particular) arranged along the inward side of the side frame 17 at the normal state. Moreover, since the side frame 17 does not exist at a position in front of the passenger-sitting front face G of the seatback 8 in the plan view of the seat (see FIG. 17), no any particular problem occurs at the vehicle side collision. Further, even if the side frame 17 deforms inward in the vehicle width direction at the vehicle side collision, this deformation may be received by the hard pad member 40, so that the safety of the passenger can be improved properly.

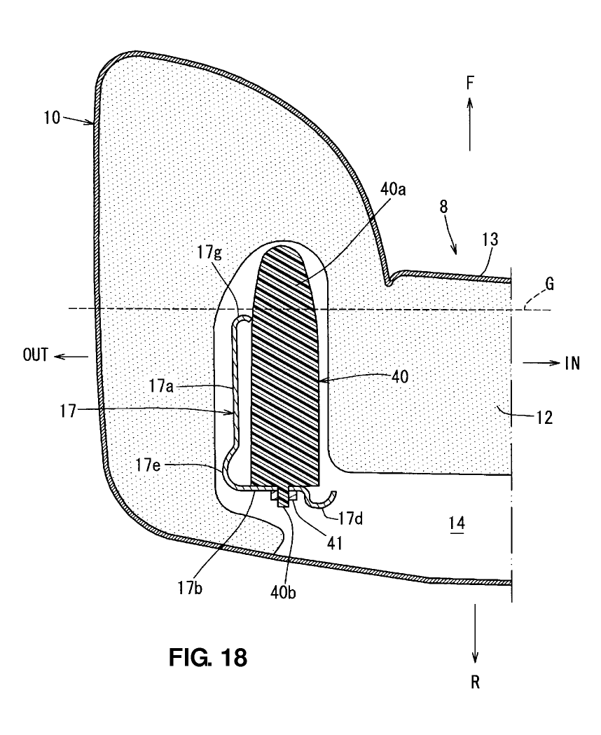

The other structures, operations and effects of the fourth embodiment shown in FIG. 17 are substantially the same as those of the above-described embodiments, so the same portions as the previous embodiments are denoted by the same reference characters in FIG. 17, specific descriptions of which are omitted here. A structure shown in FIG. 18 may be applied in place of the structure shown in FIG. 17.

While the hard pad member 40 is arranged inside the pad member 12 which forms the shape of the seatback 8 on the vehicle-inside of the side frame 17 according to the structure shown in FIG. 17, in the example shown in FIG. 18, the hard pad member 40 is fixed to the side frame 17, not being arranged inside the pad member 12.

That is, as shown in FIG. 18, plural bolts 40b (only one bolt is illustrated in FIG. 18), which may be made from hard urethane, are integrally formed at a rear end portion of the hard pad member 40. This hard pad member 40 is detachably attached to a front face of the rear portion 17b of the side frame 17 by fastening nuts 41 to the bolts 40b, so that the hard pad member 40 is arranged on the vehicle-inside of the side portion 17a of the side frame 17. Since the structure shown in FIG. 18 provides substantially the same operations and effects as those of the embodiment shown in FIG. 17, the same portions are denoted by the same reference characters in FIG. 18, specific descriptions of which are omitted here.

The present should not be limited to the above-described embodiments, and any other modifications or improvements can be applied within the scope of a sprit of the present invention. For example, the above-described seat structure of a vehicle may be arranged only on the vehicle-outside of the seatback, or on both sides of the seatback.

What is claimed is:

1. A seat structure of a vehicle, comprising:
a seatback frame provided on a vehicle-inside of a seatback which is provided at a rear portion of a seat cushion of a seat and supports a back of a passenger seated in the seat;
a side frame extending vertically beside the seatback frame; and
a pad member covering the side frame, the pad member forming a shape of the seatback,
wherein an impact reduction structure to reduce an impact from a vehicle side is provided.

2. The seat structure of a vehicle of claim 1, wherein an impact reduction portion to reduce the impact from the vehicle side is provided at said side frame, which constitutes said impact reduction structure.

3. The seat structure of a vehicle of claim 2, wherein said impact reduction portion causes deformation of the side frame by the impact from the vehicle side.

4. The seat structure of a vehicle of claim 3, wherein said impact reduction portion comprises a weak portion which is formed at the side frame so as to extend vertically, the weak portion being deformable by the impact from the vehicle side.

5. The seat structure of a vehicle of claim 4, wherein said weak portion comprises a thin portion formed at the side frame.

6. The seat structure of a vehicle of claim 4, wherein another weak portion is further formed so as to extend continuously from said weak portion toward a front end portion of the side frame.

7. The seat structure of a vehicle of claim 3, wherein said impact reduction portion is formed at a position which corresponds to a chest portion of the passenger seated in the seat.

8. The seat structure of a vehicle of claim 3, wherein a side airbag device with an airbag which is inflatable beside the passenger when a specified condition is satisfied is attached to the side frame, and an inflator to supply gas for the airbag is arranged at a specified position which is rearward from said impact reduction portion.

9. The seat structure of a vehicle of claim 3, wherein said impact reduction portion is provided in back of a passenger-sitting front face of the seatback.

10. The seat structure of a vehicle of claim 1, further comprising a side support portion which is provided at the seatback so as to support the seated passenger from the vehicle side, wherein said side frame is arranged in back of a passenger-sitting front face of the seatback at a position which corresponds to a chest portion of the passenger seated in the seat, not so as to extend forward beyond the passenger-sitting front face of the seatback, in a plan view and another hard pad member than said pad member is arranged inside the side support portion at a specified position which is located on a vehicle-inside of the side frame, which constitutes said impact reduction structure.
